(19) United States
(12) Patent Application Publication
(10) Pub. No.: US 2017/0249381 A1
(43) Pub. Date: Aug. 31, 2017

(54) MEMBER QUALITY SCORE

(71) Applicant: Linkedln Corporation, Mountain View, CA (US)

(72) Inventors: Ken Soong, Menlo Park, CA (US); Lizabeth Li, Mountain View, CA (US); Carrie Zhuqing Peng, San Jose, CA (US); Jason Schissel, Mountain View, CA (US); Yang Zhou, San Jose, CA (US)

(21) Appl. No.: 15/055,277

(22) Filed: Feb. 26, 2016

(51) Int. Cl. G06F 17/30

(52) U.S. Cl. CPC G06F 17/30675; G06F 17/30702

(57) ABSTRACT

System and methods for calculating member quality are disclosed. A social networking system, for a respective member in a plurality of members, retrieves a member profile associated with the respective member from the member profile data. The social networking system generates a member quality score for the respective member. Based on the generated member quality score, the social networking system determines whether the respective member is a quality member. The social networking system selects one or more members, from the plurality of members, for a social networking related communication, based at least in part on whether the members are determined to be quality members.

### TECHNICAL FIELD

The disclosed example embodiments relate generally to the field of social networks and, in particular, to evaluating member quality.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (email) has reduced the need for letters to be physically delivered. Instead, messages are sent over networked systems almost instantly.

Another service provided over networks is social networking services. Large social networks allow members to connect with each other and share information. Many social networks benefit from having a large and increasing number of members. To encourage additional members to join, the sign up process is free and is easy to begin and complete. As such, the possibility exists that a person may join the social network but then not participate in the services provided by the social network. Estimating whether a given member will be active allows social networks to use their resources more efficiently.

### DESCRIPTION OF THE DRAWINGS

Some example embodiments are illustrated by way of example and not limitation in the figures of the accompanying drawings.

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 is a block diagram of an exemplary data structure for member profile data, in accordance with some example embodiments.

FIG. 5 is a block diagram illustrating a system for generating member quality scores for a plurality of members of a social networking system, in accordance with some example embodiments.

FIG. 6 is a flow diagram illustrating a method, in accordance with some example embodiments, for generating a member quality score.

FIGS. 7A-7C are flow diagrams illustrating a method, in accordance with some example embodiments, for generating a member quality score for members of a social networking system.

FIG. 8 is a block diagram illustrating an architecture of software, which may be installed on any of one or more devices, in accordance with some example embodiments.

FIG. 9 is a block diagram illustrating components of a machine, according to some example embodiments.

Like reference numerals refer to corresponding parts throughout the drawings.

### DETAILED DESCRIPTION

The present disclosure describes methods, systems, and computer program products for determining member quality for members of a social networking system. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, a social networking system receives a request to determine member quality for a group of members. In some example embodiments, the group of members are members who have recently signed up with the social networking system. In other example embodiments, the group of members are a plurality of members being considered for a specific experiment, offer, request, or communication.

In some example embodiments, the social networking system needs to evaluate each member in the group of members to determine which members are quality members (e.g., based on their engagement with and contribution to the social networking system) and which members are non-quality or low-engagement members. To make this evaluation the social networking system accesses stored member data.

Stored member data includes data from the member profile, including both information submitted by the member and information inferred by the social networking system based on the member's data and interactions.

In some example embodiments, the social networking system considers a number of factors including, but not limited to, a completion percentage for the member profile, the number of social contacts a member has, whether the member has an associated profile picture, whether the member has a confirmed email, whether the member is reachable, whether the member has sent an invitation, whether the member has imported an address book from a another web service (e.g., a member can import an address book from an email service), whether the member has posted an article to the members activity feed, whether the member has interacted with content, whether the member has had a discussion on the social networking system, whether the member has posted an feed update, whether the member has commented through the social networking system, whether the member has signed up for premium service, whether the member is endorsed or has endorsed other members, whether the member has followed people and, if so, how many, and so on. In some example embodiments, the social networking system uses this data to generate a member quality score. For example, members with a more complete profile (e.g., more information filled in on their profile) have a higher member quality score than members with less information in their profile. Similarly, members who have a large number of social contacts can receive a higher member quality score than members who have fewer.

In some example embodiments, the social networking system uses the calculated member quality score to categorize each member into one of two categories. In some example embodiments; the two categories are quality member and non-quality member. In some example embodiments, if a member is determined to be a non-quality member, the social networking system then identifies one or more actions the member can take or information that the member can supply that would make the member a quality member. In some example embodiments; the social networking system sends a recommendation to the member to perform the identified action or supply the identified information.

In some example embodiments, the social networking system can then make decisions about what members are best to be targeted with a particular offer, promotion, experiment, and so on. For example, when testing a new interface component, tests that are randomly distributed among all members may have different results than tests that are only given to quality members.

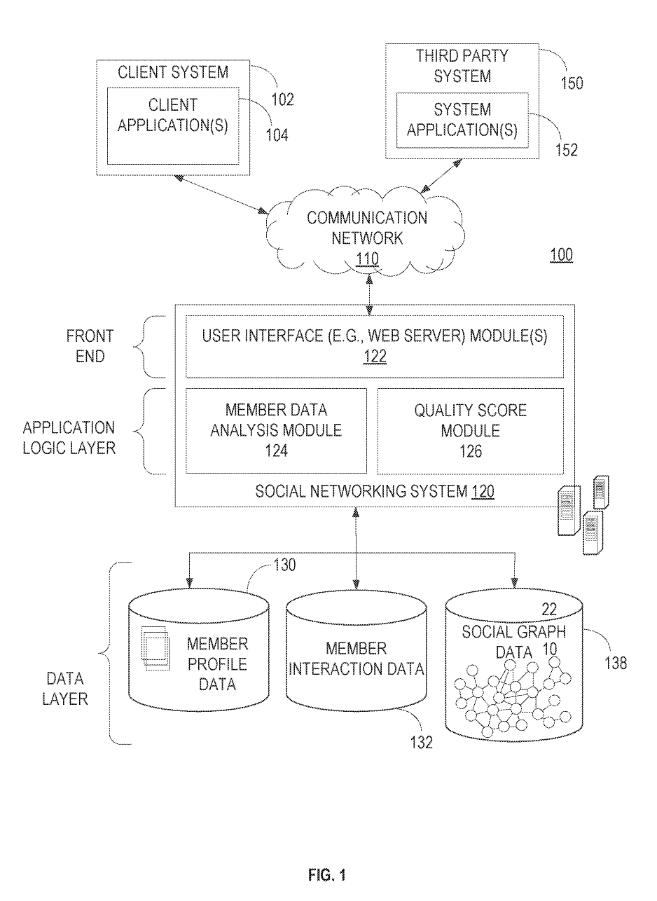

FIG. 1 is a network diagram depicting a client-social networking system environment 100 that includes various functional components of a social networking system 120; in accordance with some example embodiments. The client-social networking system environment 100 includes one or more client systems 102 and the social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, the client system 102 is an electronic device, such as a personal computer (PC), a laptop, a smartphone, a tablet, a mobile phone; or any other electronic device capable of communication with the communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the social networking system 120 and to display information received from the social networking system 120.

In some example embodiments, the client system 102 includes an application specifically customized for communication with the social networking system 120 (e.g., a LinkedIn iPhone application). In some example embodiments, the social networking system 120 is a server system that is associated with one or more services.

In some example embodiments, the client system 102 sends a request to the social networking system 120 for a webpage associated with the social networking system 120. For example, a member uses the client system 102 to log into the social networking system 120 and view a stream of recent social networking system events (e.g., activities and information shared by the social contacts of the member). In response, the client system 102 receives the requested stream of social networking events and displays that data in a user interface on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although the social networking system 120 is depicted in FIG. 1 as having a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transfer Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, member interaction data 132 (e.g., data describing the interactions that a member has with the social networking system 120 or with other members though the social networking system 120), and social graph data 138, which is data stored in a particular type of database that uses graph structures with nodes, edges, and properties to represent and store data. Of course, in various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes or is associated with the member interaction data 132. In other example embodiments, the member interaction data 132 is distinct from, but associated with, the member profile data 130. The member interaction data 132 stores data detailing the various interactions each member has through the social networking system 120. In some example embodiments, interactions include posts, likes, messages, adding or removing social contacts, and adding or removing member content items (e.g., a message or like), while others are general interactions (e.g., posting a status update) and are not related to another particular member. Thus, if a given member interaction is directed towards or includes a specific member, that member is also included in the membership interaction record.

Once registered, a member may invite other members, or be invited by other members, to connect via the social networking system 120. A “connection” may include a bilateral agreement by the members, such that both members acknowledge the establishment of the connection. Similarly, in some example embodiments, a member may elect to “follow” another member. In contrast to establishing a “connection,” the concept of “following” another member typically is a unilateral operation and, at least in some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities, and are represented in the social graph data 138.

The social networking system 120 may provide a broad range of other applications and services that allow members the opportunity to share and receive information, often customized to the interests of the member. In some example embodiments, the social networking system 120 may include a photo sharing application that allows members to upload and share photos with other members. As such, at least in some example embodiments, a photograph may be a property or entity included within a social graph. In some example embodiments, members of the social networking system 120 may be able to self-organize into groups, or interest groups, organized around a subject matter or topic of interest. In some example embodiments, the data for a group may be stored in a database. When a member joins a group, his or her membership in the group will be reflected in the member profile data 130 and the social graph data 138.

In some example embodiments, the application logic layer includes various application server modules, which, in conjunction with the user interface module(s) 122, generate various user interfaces (e.g., web pages) with data retrieved from various data sources in the data layer. In some example embodiments, individual application server modules are used to implement the functionality associated with various applications, services, and features of the social networking system 120. For instance, a messaging application, such as an email application, an instant messaging application, or some hybrid or variation of the two, may be implemented with one or more application server modules. Similarly, a search engine enabling members to search for and browse member profiles may be implemented with one or more application server modules.

A member data analysis module 124 or a quality score module 126 can also be included in the application logic layer. Of course, other applications or services that utilize the member data analysis module 124 or the quality score module 126 may be separately implemented in their own application server modules.

As illustrated in FIG. 1, in some example embodiments, the member data analysis module 124 and the quality score module 126 are implemented as services that operate in conjunction with various application server modules. For instance, any number of individual application server modules can invoke the functionality of the member data analysis module 124 or the quality score module 126. However, in various alternative example embodiments, the member data analysis module 124 or the quality score module 126 may be implemented as their own application server modules such that they operate as standalone applications.

Generally, the member data analysis module 124 accesses data in the member profile data 130 and the member interaction data 132. Using the accessed data, the member data analysis module 124 determines what information the member has already submitted to the social networking system 120. In some example embodiments, the member data analysis module 124 determines what percentage of possible information is already in the member's member profile.

For example, a member profile includes data fields for up to fifty pieces of information (name, birth date, current employer, relationship status, and so). If the member has supplied data for twenty-five of those fields, the member data analysis module 124 determines that the member has provided fifty percent of needed data.

In some example embodiments, one or more of the data fields in the member profile are determined to be more important or key to services provided by the social networking system 120 (e.g., employment, education, location, and so), and thus the member data analysis module 124 determines the percentage of important data fields that are filled in.

In some example embodiments, the member data analysis module 124 accesses the social graph data 138 of the member and determines what connections the member has made and who the member is friends with, following, or otherwise connected to. In some example embodiments, the more connection, the more the member data analysis module 124 determines that the member contributes to the social networking system 120.

In some example embodiments, the member data analysis module 124 accesses the member interaction data 132 to determine how active a member is and what types of interactions the member engages in.

In some example embodiments, a member with a large number of interactions will generally be considered more valuable than a member that has very few interactions. In some example embodiments, the type of interactions (e.g., following businesses, interaction with marketing materials, and so on) will partially determine whether the interactions are considered indicative of member quality or not.

In some example embodiments, the quality score module 126 uses the data gathered by the member data analysis module 124 to generate a quality score for one or more members. In some example embodiments, the quality score represents the degree to which the member is a contributing member to the social networking system 120. In some example embodiments, the quality score is based on the data the member has provided, the social graph data of the member, and the member interactions of the member over a given period of time.

In some example embodiments, the quality score module 126 also considers the level of activity with the social networking system 120 that the member has engaged in. For example, members who log on and interact with the social networking system 120 will generally have higher member quality scores than members who do not, all other things being equal.

In some example embodiments, the member quality score is based on a profile score that represents how complete the member profile is. For example, a member who has only supplied an email address will have a lower member quality score than a member who has supplied an email address, a job title, a location, a work history, and so on, all other things being equal.

In some example embodiments, the member quality score is at least partially based on whether the social networking system 120 can contact the member. For example, if the social networking system 120 has a dedicated application for smartphones, the quality score module 126 will determine whether a particular member has the dedicated application installed. If the member does have the dedicated application installed, the member will have a higher member quality score than a member who is otherwise similar but does not have the dedicated application installed.

In some example embodiments, the quality score module 126 also uses, a number of factors including, a completion percentage for the member profile, the number of social contacts a member has, whether the member has an associated profile picture, whether the member has a confirmed email, whether the member is reachable, whether the member has sent an invitation, ABI, whether the member has interacted with content, whether the member has had a discussion on the social networking system, whether the member has posted an feed update, whether the member has commented through the social networking system, whether the member has signed up for premium service, whether the member is endorsed or has endorsed other members, whether the member has followed people and; if so, how many, and so on the number of other members that a member follows to calculate the member quality score.

In some example embodiments, the member quality score is a binary value that indicates whether the social networking system 120 estimates that the member is a quality member or not. In some example embodiments, the quality score module 126 determines whether the member crosses a threshold of quality. In accordance with a determination that the member crosses a predetermined threshold of quality, the member is assigned a quality score indicating that the member is a quality member.

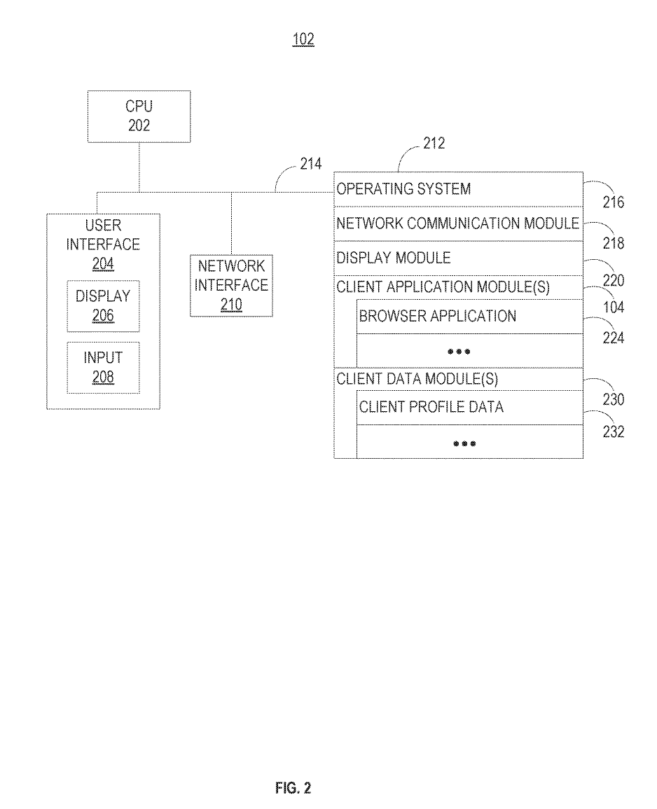

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means 208 such as a keyboard, a mouse, a touch sensitive display, or other input buttons. Furthermore, some client systems 102 use a microphone and voice recognition to supplement or replace the keyboard.

The memory 212 includes high-speed random-access memory, such as dynamic random-access memory (DRAM), static random-access memory (SRAM), double data rate random-access memory (DDR RAM), or other random-access solid state memory devices; and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more network interfaces 210 (wired or wireless) and one or more communication networks 110, such as the Internet, other WANs, LANs, metropolitan area networks (MANS), etc.;
a display module 220 for enabling the information generated by the operating system 216 and client application(s) 104 to be presented visually on the display device 206;
one or more client applications 104 for handling various aspects of interacting with the social networking system 120 (FIG. 1), including but not limited to:
   a browser application 224 for requesting information from the social networking system 120 (e.g., job listings) and receiving responses from the social networking system 120; and
client data module(s) 230 for storing data relevant to the clients, including but not limited to:
   client profile data 2 for storing profile data related to a member of the social networking system 120 associated with the client system 102.

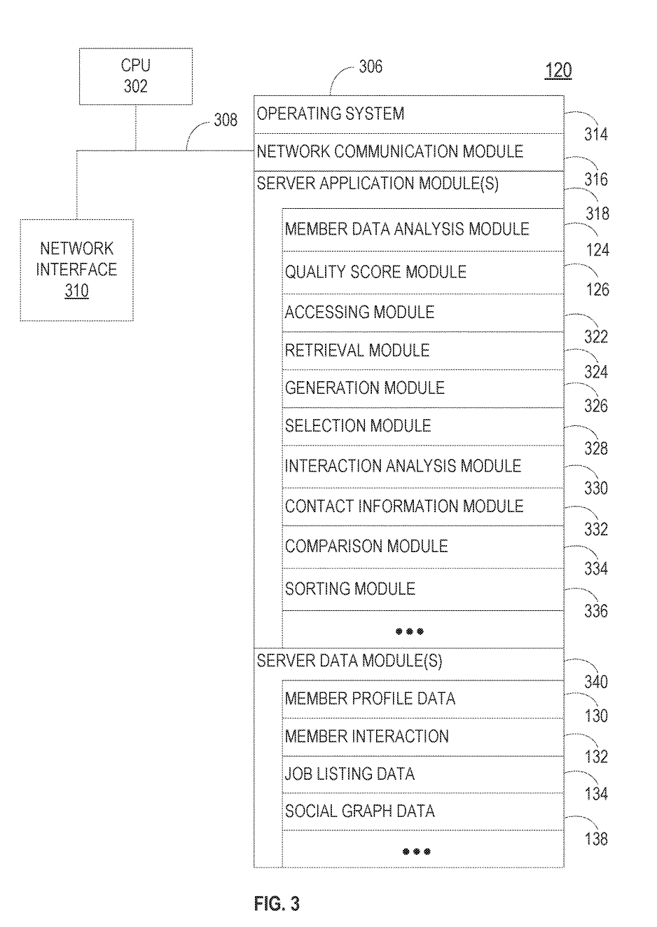

FIG. 3 is a block diagram further illustrating the social networking system 120, in accordance with some example embodiments. Thus, FIG. 3 is an example embodiment of the social networking system 120 in FIG. 1. The social networking system 120 typically includes one or more CPUs 302, one or more network interfaces 310, memory 306, and one or more communication buses 308 for interconnecting these components. The memory 306 includes high-speed random-access memory, such as DRAM, SRAM, DDR RAM, or other random-access solid state memory devices; and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternatively the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more network interfaces 310 (wired or wireless) and one or more communication networks 110, such as the Internet, other WANs, LANs, MANs, and so on;
one or more server application modules 318 for performing the services offered by the social networking system 120, including but not limited to:
   a member data analysis module 124 for analyzing member profile data retrieved from the member profile data 130;
   a quality score module 126 for generating a quality score for each member based at least in part on analysis of the member profile data 130;
   an accessing module 322 for accessing member profile data 130 for one or more members of the social networking system 120;
   a retrieval module 324 for retrieving member profile data 130 for particular members from the member profile data 130;
   a generation module 326 for generating member quality score for a plurality of members based on data stored about each member;
   a selection module 328 for selecting one or more members, from a plurality of members, for a social networking related communication, based at least in part on whether the members are determined to be quality members;
   an interaction analysis module 330 for analyzing the member interactions associated with a particular member of the social networking system 120 based on the member interaction data 132;
   a contact information module 332 for determining whether a particular member profile of the social networking system 120 includes contact information for the associated member;
   a comparison module 334 for comparing member quality scores with a predetermined threshold score value; and
   a sorting module 336 for sorting members into one of two groups of members based on the member quality score associated with each member; and
server data module(s) 340, holding data related to the social networking system 120, including but not limited to:
   member profile data 130, including both data provided by the member, who will be prompted to provide some personal information, such as his or her name, age (e.g.; birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data 138, overall trend data for the social networking system 120, and so on;
   member interaction data 132 including data describing the interactions that a member has with the social networking system 120 or with other members though the social networking system 120;
   job listing data 134 including data representing one or more job listing submitted to the social networking system 120; and
   social graph data 138 including data that represents members of the social networking system 120 and the social connections between them.

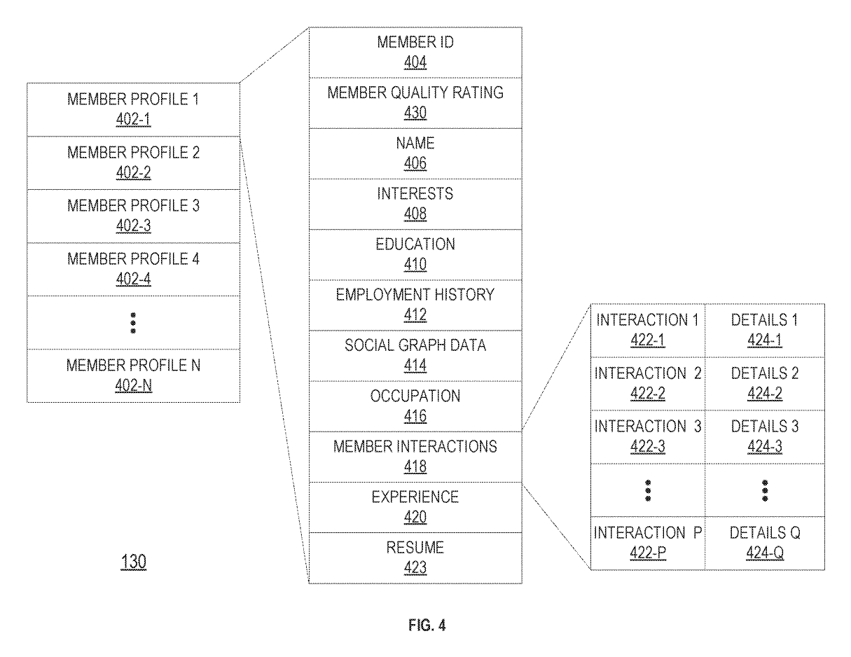

FIG. 4 is a block diagram of an exemplary data structure for the member profile data 130 for storing member profiles, in accordance with some example embodiments. In accordance with some example embodiments, the member profile data 130 includes a plurality of member profiles 402-1 to 402-N, each of which corresponds to a member of the social networking system 120.

In some example embodiments, a respective member profile 402 stores a unique member ID 404 for the member profile 402, a member quality rating 430 for the member, a name 406 for the member (e.g., the member's legal name), member interests 408, member education history 410 (e.g., the high school and universities the member attended and the subjects studied), employment history 412 (e.g., the member's past and present work history with job titles), social graph data 414 (e.g., a listing of the member's relationships as tracked by the social networking system 120), occupation 416, member interactions 418, experience 420 (for listing experiences that do not fit under other categories, such as community service or serving on the board of a professional organization), and a detailed member resume 423.

In some example embodiments, a member profile 402 includes a list 418 of member interactions 422-1 to 422-P and associated interaction details 424-1 to 424-P. Each interaction 422-1 to 422-P describes one member interaction with the social networking system 120, including but not limited to a member logging into the social networking system 120, a member liking or commenting on a content piece, sending a message to another member, posting content, adding information to the member profile, following or liking another member or organization, and so on. Each interaction 422-1 to 422-P is recorded and stored in the member interaction database 132 at the social networking system 120.

The interaction details 424-1 to 424-P associated with each interaction 422-1 to 422-P record what the interaction represented, including but not limited to which members, content items, and actions were involved in a particular interaction.

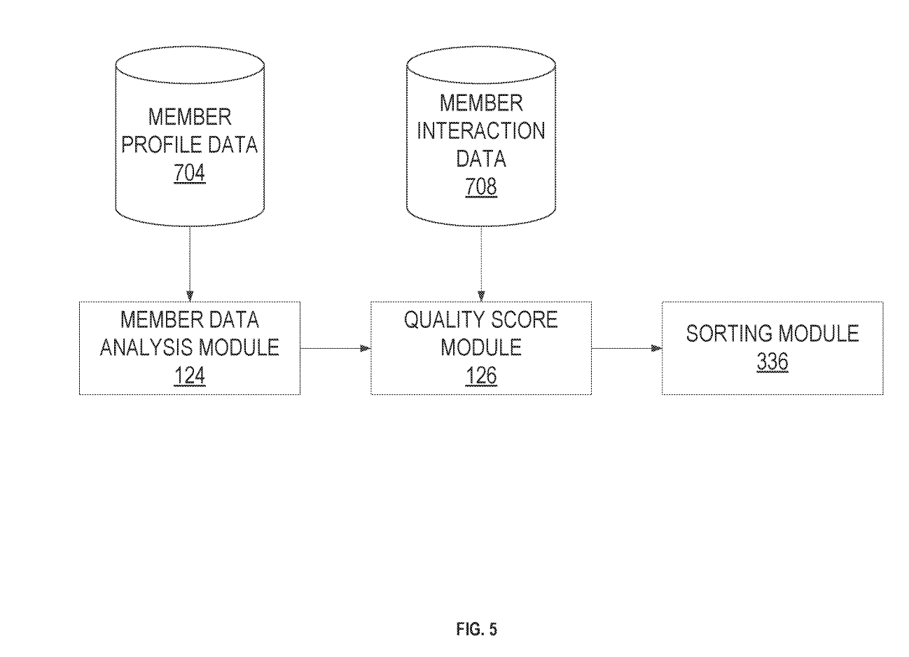

FIG. 5 is a block diagram illustrating a system for generating member quality scores for a plurality of members of the social networking system 120.

In some example embodiments, the member data analysis module 124 receives a request to generate member quality scores for a plurality of members. In some example embodiments, the request is generated for a batch of new members of the social networking system 120, In other example embodiments, the request is generated for a plurality of non-active members (e.g., members who haven't interacted with the social networking 120 for some predetermined amount of time.).

In some example embodiments, the member data analysis module 124 uses the received list of members for whom member quality scores are requested to retrieve member profile data 130 for those members. For example, the member profile data 130 includes data submitted by the member during the signup process or subsequent updates received from the member, including the member's name, location, education, work history, and so on.

In some example embodiments, the member data analysis module 124 transmits the retrieved member profile data 130 to the quality score module 126. In some example embodiments, the quality score module 126 then accesses the member interaction data 132 for each member in the plurality of members. The quality score module 126 then generates a quality score based on the member profile data 130 and the member interaction data 132.

In some example embodiments, the sorting module 336 then sorts the members into a first group of members (e.g., quality members) and a second group of members (e.g., not determined to be quality members).

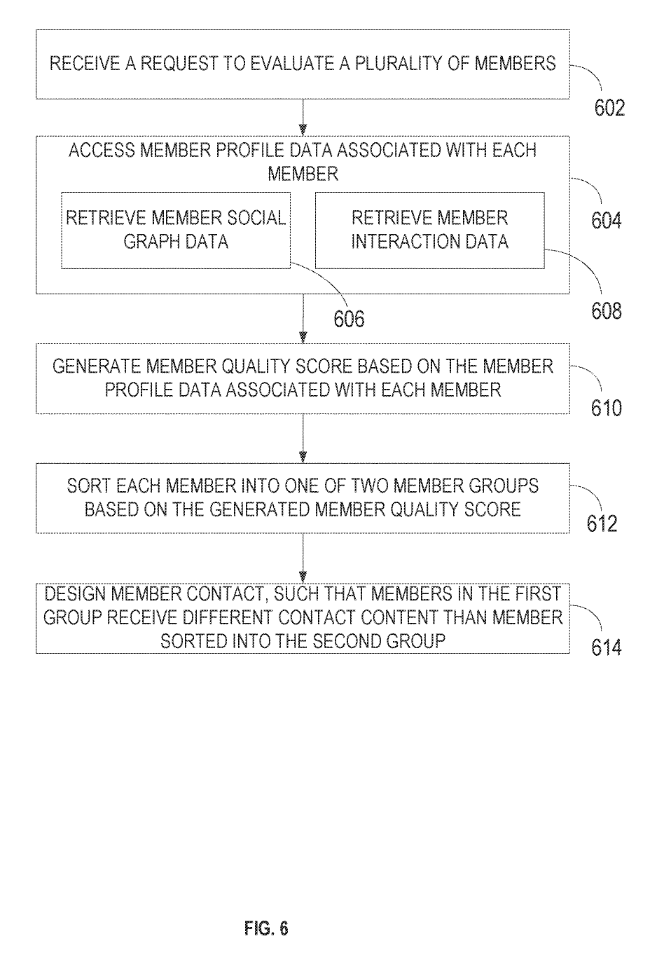

FIG. 6 is a flow diagram illustrating a method, in accordance with some example embodiments, for generating a member quality score. Each of the operations shown in FIG. 6 may correspond to instructions stored in a computer memory or computer-readable storage medium. In some embodiments, the method described in FIG. 6 is performed by a social networking system (e.g., social networking system 120 in FIG. 1). However, the method described can also be performed by any other suitable configuration of electronic hardware.

In some embodiments, the method is performed by a social networking system (e.g., social networking system 120 in FIG. 1) including one or more processors and memory storing one or more programs for execution by the one or more processors.

In some example embodiments, the social networking system (e.g., social networking system 120 in FIG. 1) receives (602) a request to evaluate a plurality of members. In some example embodiments, the request is generated for a group of new member sign-ups that need to be evaluated for quality. In other example embodiments, the social networking system (e.g., social networking system 120 in FIG. 1) wants to invite a group of members to a particular trial; experiment, or offer and needs to identify, from a group of members, the members that have the highest member quality score.

In some example embodiments, the social networking system (e.g., social networking system 120 in FIG. 1) accesses (604) member profile data for each member in the plurality of members for whom evaluation is requested. In some example embodiments, the member profile data is stored in a database associated with the social networking system (e.g., social networking system 120 in FIG. 1).

Accessing member profile data includes, among other things, the social networking system (e.g., social networking system 120 in FIG. 1) retrieving (606) member social graph data. Member social graph data includes any data that describes connections between members of the social networking system (e.g., social networking system 120 in FIG. 1). For example, members can connect to each other as friends or contacts and those connections will be recorded in the social graph data. In addition, the social graph data can record instances of a member following (e.g., opting to receive updates about) specific members or organizations (e.g., companies or brands).

In some example embodiments, the social networking system (e.g., social networking system 120 in FIG. 1) retrieves (608) member interaction data from a member interaction database as part of accessing member profile data. Member interactions include any action that a member takes through or with the social networking system (e.g., social networking system 120 in FIG. 1), For example, any time a member clicks on a link, views content, sends a message, likes a content item or comment, and so on, the social networking system (e.g., social networking system 120 in FIG. 1) records that member interaction in a database. In some example embodiments, the more often a member interacts with or through the social networking system (e.g., social networking system 120 in FIG. 1), the higher the member's member quality score will be, all other things being equal.

In some example embodiments, the social networking system (e.g., social networking system 120 in FIG. 1) generates (610) a member quality score for each member based on the member profile data associated with each member. In some example embodiments, the generation takes into account the percentage of the member profile data that is complete, whether the member has installed a social networking system (e.g., social networking system 120 in FIG. 1) specific application at their client system (e.g., the client system 102 in FIG. 1), whether the member has contact information associated with them, the number of other members the member follows or is connected to, and so on.

For example, the member quality score uses a formula such as:

mq=w1*profile completion+w2*number of contacts+w3*is_reachable

In this formula, the member quality score (mq) is calculated by determining the profile completion percentage, the number of contacts that a member has, and whether that member is reachable. Each factor is then weighted based on a determined weighting factor. In this example, w1 is the weighting factor associated with profile completion, w2 is the weighting factor associated with the number of contacts, and w3 is the weighting factor associated with whether the member is reachable or not. In some example embodiments, the weighting are determined based on a training algorithm that uses past information to determine the most appropriate weights to most accurately measure member quality. In other example embodiments, other factors could be used in the formula, each with its own weighting.

In some example embodiments, the member quality score is represented as a value between 0 and 1, wherein 0 is the lowest possible quality score and 1 is the highest. In some example embodiments, the social networking system (e.g., social networking system 120 in FIG. 1) sorts (612) the plurality of members into one of two groups based on the generated member quality score. For example, the social networking system (e.g., social networking system 120 in FIG. 1) has a predetermined member quality score threshold. Any member that has a member quality score that exceeds the threshold member quality score is sorted into the first member group, and members that have a member quality score that falls below the threshold member quality score are sorted into the second group. In some example embodiments, the first group is a quality member group and the second group is for members who do not meet that quality member minimum threshold.

In some example embodiments, the social networking system (e.g., social networking system 120 in FIG. 1) designs (614) a member contact (e.g., an email or other message that conveys a promotion or information) such that members in the first member group receive a different contact than members sorted into the second group. For example, the social networking system (e.g., social networking system 120 in FIG. 1) is looking to test new user interface features for a webpage provided by the system. The social networking system (e.g., social networking system 120 in FIG. 1) first determines a group of members who meet criteria for a given experiment (e.g., members from Dallas that have been members for less than six months) and then evaluates them to determine which members are the quality members. The quality members are then selected to participate in an experiment with the new features.

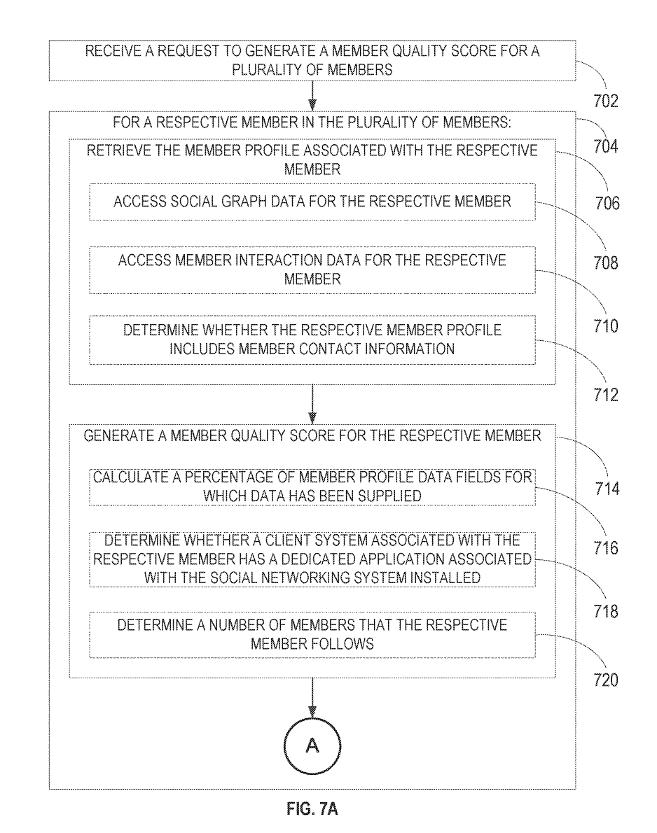

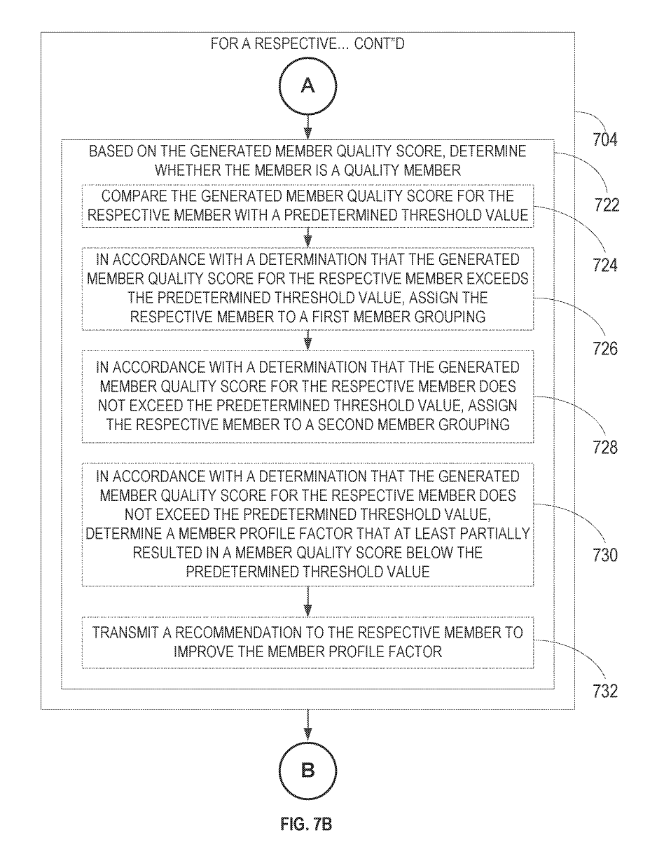

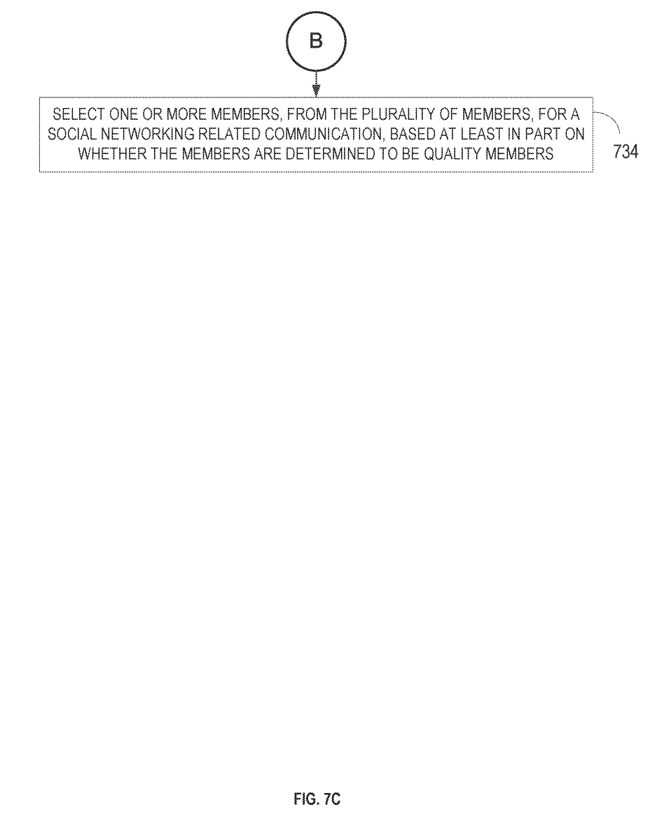

FIG. 7A is a flow diagram illustrating a method, in accordance with some example embodiments, for generating a member quality score for members of a social networking system (e.g., social networking system 120 in FIG. 1). Each of the operations shown in FIG. 7A may correspond to instructions stored in a computer memory or computer-readable storage medium. Optional operations are indicated by dashed lines (e.g., boxes with dashed-line borders). In some embodiments, the method described in FIG. 7A is performed by the social networking system (e.g., social networking system 120 in FIG. 1), However, the method described can also be performed by any other suitable configuration of electronic hardware.

In some embodiments the method is performed by a social networking system (e.g., social networking system 120 in FIG. 1) including one or more processors and memory storing one or more programs for execution by the one or more processors.

In some example embodiments, the social networking system (e.g., social networking system 120 in FIG. 1) receives (702) a request to generate a member quality score for a plurality of members. In some example embodiments, the social networking system (e.g., social networking system 120 in FIG. 1) had identified a group of members based on one or more criteria (e.g., the location of the members and the age of the accounts) and wants to determine which members in that group are quality members (e.g., members who contribute to the overall social networking system in a positive way) and which members are not quality members (e.g., members that have very little interaction with or through the social networking system or who signed up but have not returned).

In response to receiving the request to generate a member quality score for a plurality of members, the social networking system (e.g., social networking system 120 in FIG. 1), for a respective member in the plurality of members (704), retrieves (706) the member profile associated with the respective member. In some example embodiments, the member profile is stored at a member profile database at the social networking system (e.g., social networking system 120 in FIG. 1) and the data in the member profile is either received from the member or inferred based on the member's interactions with the social networking system (e.g., social networking system 120 in FIG. 1).

In some example embodiments, when the social networking system (e.g., social networking system 120 in FIG. 1) retrieves the member profile associated with the respective member, that includes the social networking system (e.g., social networking system 120 in FIG. 1) accessing (708) social graph data for the respective member. In some example embodiments, the social networking system (e.g., social networking system 120 in FIG. 1) first determines whether there is any social graph data stored for the member at all (e.g., if the member did not make connections with other members or organizations there may be no social graph data to retrieve).

In some example embodiments, the social graph data includes any stored data that represents relationships between members of the social networking system (e.g., social networking system 120 in FIG. 1) or connections to organizations (e.g., following a company).

The social networking system (e.g., social networking system 120 in FIG. 1) accesses (710) member interaction data for the respective member. In some example embodiments, the social networking system (e.g., social networking system 120 in FIG. 1) stores a series of member interaction records in a database, the member interaction records describing interactions that each member has had with the social networking system (e.g., social networking system 120 in FIG. 1), including, but not limited to, logging in, viewing a content item (e.g., an article, video, and so on), liking or commenting on a post or status update, sending messages, and so on.

In some example embodiments, the social networking system (e.g., social networking system 120 in FIG. 1) also determines (712) whether the respective member profile includes member contact information. In some example embodiments, member contact information includes but is not limited to an email address, a member identification for another online service, a cell phone number, a messaging application identification, and so on. In some example embodiments, member contact information is any information that allows the social networking system (e.g., social networking system 120 in FIG. 1) to contact the member when the member is not logged onto the social networking system (e.g., social networking system 120 in FIG. 1).

In some example embodiments, the social networking system (e.g., social networking system 120 in FIG. 1) generates (714) a member quality score for the respective member. In some example embodiments, the member quality score reflects the degree to which a member is considered a valuable contributing member of the social networking system (e.g., social networking system 120 in FIG. 1), Thus, the member quality score is not solely a reflection of the revenue expected to be derived from a particular member.

In some example embodiments, to generate a member quality score, the social networking system (e.g., social networking system 120 in FIG. 1) calculates (716) a percentage of member profile data fields for which data has been supplied. For example, if there are 20 data fields in a member profile, the social networking system (e.g., social networking system 120 in FIG. 1) determines what percentage of the fields have been filled out. In some example embodiments, different data fields have different weightings, such that heavily weighted data fields affect the overall member quality score more than non-heavily weighted data fields.

In some example embodiments, the social networking system (e.g., social networking system 120 in FIG. 1) determines (718) whether a client system associated with the respective member has a dedicated application associated with the social networking system installed. In some example embodiments, a mobile phone or tablet application has been created that allows members to access the social networking system (e.g., social networking system 120 in FIG. 1) without using a traditional web browser. The social networking system (e.g., social networking system 120 in FIG. 1) determines whether the respective member has such an application installed on their device and generates a higher member quality score for members who do have it installed than for members who do not have such an application installed, all other things being equal.

In some example embodiments, the social networking system (e.g., social networking system 120 in FIG. 1) determines (720) the number of members that the respective member is following (or in some cases is connected to). Members who are following at least a predetermined number of other members (e.g., 5) have higher estimated member quality scores than members who are not.

In some example embodiments, the generated member quality score is based, at least partially, on whether the respective member profile includes contact information for the respective member, such that members that can be contacted by the social networking system (e.g., social networking system 120 in FIG. 1) have a higher member quality score than members who cannot be contacted.

FIG. 7B is a flow diagram illustrating a method, in accordance with some example embodiments, for generating a member quality score for members of a social networking system (e.g., social networking system 120 in FIG. 1). Each of the operations shown in FIG. 7B may correspond to instructions stored in a computer memory or computer-readable storage medium. Optional operations are indicated by dashed lines (e.g., boxes with dashed-line borders). In some embodiments, the method described in FIG. 7B is performed by the social networking system (e.g., social networking system 120 in FIG. 1). However, the method described can also be performed by any other suitable configuration of electronic hardware.

In some embodiments the method is performed by a social networking system (e.g., social networking system 120 in FIG. 1) including one or more processors and memory storing one or more programs for execution by the one or more processors.

Based on the generated member quality score, the social networking system (e.g., social networking system 120 in FIG. 1) determines (722) whether the member is a quality member. Determining whether the member is a quality member further includes the social networking system (e.g., social networking system 120 in FIG. 1) comparing (724) the generated member quality score for the respective member with a predetermined threshold value. For example, if the member quality score is a number between 0 and 1, the predetermined threshold value could be 0.5. In some example embodiments, the predetermined threshold value is determined based on aggregate data about all members of the social networking system (e.g., social networking system 120 in FIG. 1). In other example embodiments, a predetermined threshold value can be calculated for a particular set of members (e.g., a group of members who are currently dormant and signed up between 6 months and a year ago).

In some example embodiments, in accordance with a determination that the generated member quality score for the respective member exceeds the predetermined threshold value, the social networking system (e.g., social networking system 120 in FIG. 1) assigns (726) the respective member to a first member grouping. For example, the first member grouping is a grouping of members considered to be quality members.

In accordance with a determination that the generated member quality score for the respective member does not exceed the predetermined threshold value, the social networking system (e.g., social networking system 120 in FIG. 1) assigns (728) the respective member to a second member grouping. In this example, the second member grouping is a group of members determined not to be quality members.

In some example embodiments, in accordance with a determination that the generated member quality score for the respective member does not exceed the predetermined threshold value, the social networking system (e.g., social networking system 120 in FIG. 1) determines (730) a member profile factor that at least partially resulted in the member quality score being below the predetermined threshold value. For example, the social networking system (e.g., social networking system 120 in FIG. 1) determines which aspects of the member profile data caused the member quality score to fall below the threshold. The social networking system (e.g., social networking system 120 in FIG. 1) may determine that adding contact information for a member, having the member install a dedicated application, encouraging the member to follow more members, increasing the percentage of completed data fields in the member profile data, or increasing the number of social contacts the member has would increase the member quality score above the threshold.

In some example embodiments, the social networking system (e.g., social networking system 120 in FIG. 1) estimates the member quality score increase for each potential addition to the member profile data. The potential addition that results in the highest member quality score is selected as the member profile factor that at least partially results in the member quality score falling below the threshold.

In some example embodiments, the social networking system (e.g., social networking system 120 in FIG. 1) transmits (732) a recommendation to the respective member to improve the member profile factor. For example, the social networking system (e.g., social networking system 120 in FIG. 1) determines that the member installing a dedicated application would result in the member profile score associated with the member rising above the threshold level, and as such, the social networking system (e.g., system 120 in FIG. 1) transmits a suggestion to the member to install the dedicated application.

FIG. 7C is a flow diagram illustrating a method, in accordance with some example embodiments, for generating a member quality score for members of a social networking system (e.g., social networking system 120 in FIG. 1). Each of the operations shown in FIG. 7C may correspond to instructions stored in a computer memory or computer-readable storage medium. In some embodiments, the method described in FIG. 7C is performed by the social networking system (e.g., social networking system 120 in FIG. 1). However, the method described can also be performed by any other suitable configuration of electronic hardware.

In some embodiments the method is performed at a social networking system (e.g., social networking system 120 in FIG. 1) including one or more processors and memory storing one or more programs for execution by the one or more processors.

In some example embodiments, the social networking system (e.g., social networking system 120 in FIG. 1) selects (734) one or more members, from the plurality of members, for a social networking related communication, based at least in part on whether the members are determined to be quality members.

In some example embodiments, the communication is a reactivation email and the members are dormant members who are evaluated to determine which dormant members are quality and which are not. Then, social networking system (e.g., social networking system 120 in FIG. 1) resources can be used more efficiently to target those members who were quality members in the past and/or would be most likely to become quality again.

### Software Architecture

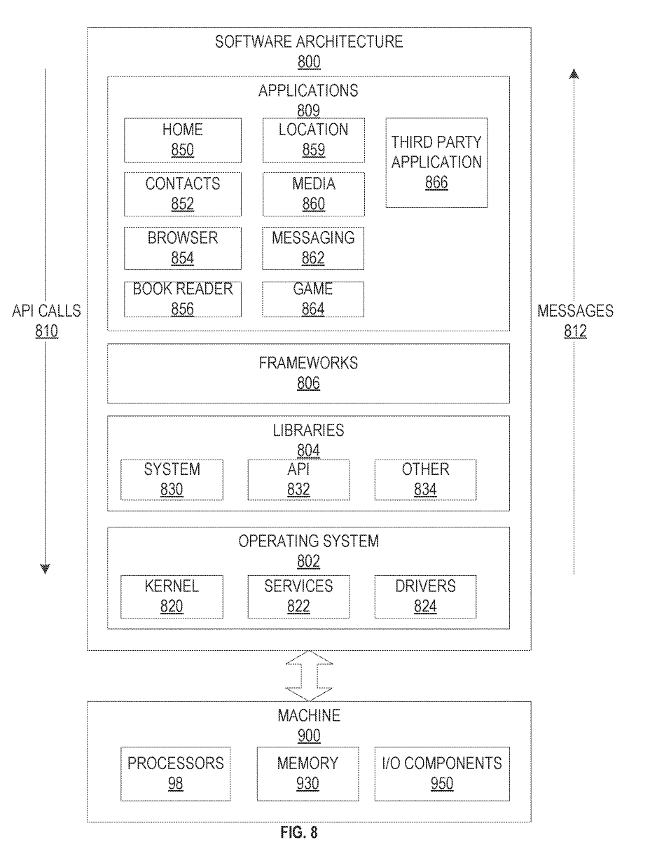

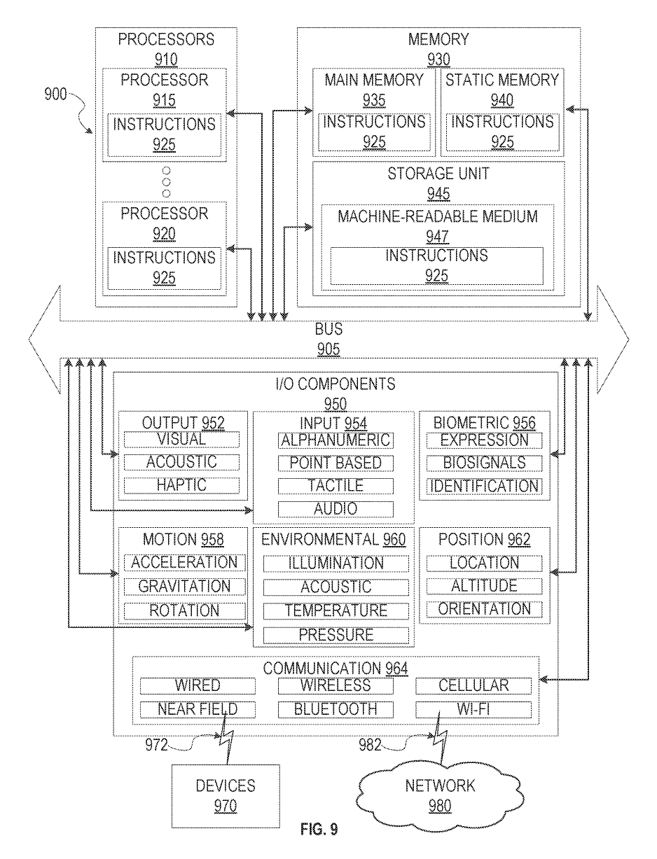

FIG. 8 is a block diagram illustrating an architecture of software 800, which may be installed on any one or more of the devices of FIG. 1. FIG. 8 is merely a non-limiting example of an architecture of software 800 and it will be appreciated that many other architectures may be implemented to facilitate the functionality described herein. The software 800 may be executing on hardware such as a machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 809. Operationally, the applications 809 may invoke APT calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 809. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPEG4, H.264, MP3, AAC, AMR, NG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 809.

The frameworks 806 may provide a high-level common infrastructure that may be utilized by the applications 809. For example, the frameworks 806 may provide various graphical user interface (GUI) functions, high-level resource management, high-level location services, and so forth. The frameworks 806 may provide a broad spectrum of other APIs that may be utilized by the applications 809, some of which may be specific to a particular operating system 802 or platform.

The applications 809 include a home application 850, a contacts application 852, a browser application 854, a book reader application 856, a location application 859, a media application 860, a messaging application 862, a game application 864, and a broad assortment of other applications such as a third party application 866. In a specific example, the third party application 866 (e.g., an application developed using the Android™ or iOS™ software development kit (SDK) by an entity other than the vendor of the particular platform) may be mobile software running on a mobile operating system such as iOS™ Android™, Windows® Phone, or other mobile operating systems. In this example, the third party application 866 may invoke the API calls 810 provided by the mobile operating system, such as the operating system 802, to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software 800, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a PC, a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 915 and a processor 920, which may execute the instructions 925. The term “processor” is intended to include multi-core processors 910 that may comprise two or more independent processors 915, 920 (also referred to as “cores”) that may execute the instructions 925 contemporaneously. Although FIG. 9 shows multiple processors 910, the machine 900 may include a single processor 910 with a single core, a single processor 910 with multiple cores (e.g., a multi-core processor), multiple processors 910 with a single core, multiple processors 910 with multiple cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, the static memory 940, and the processors 910 may be considered machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown, in an example embodiment, to be a single medium, the term “machine-readable medium” should be taken to include a single medium or multiple media (e.g., a centralized or distributed database, or associated caches and servers) able to store the instructions 925. The term “machine-readable medium” shall also be taken to include any medium, or combination of multiple media, that is capable of storing instructions (e.g., instructions 925) for execution by a machine (e.g., machine 900), such that the instructions 925, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine 900 and/or any of a wide variety of peripheral devices (e.g., a peripheral device coupled via a USB).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HTTP). Similarly, the instructions 925 may be transmitted and/or received using a transmission medium via the coupling 972 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software 800.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A computer-implemented method using at least one computer processor, the method comprising:
for a respective member in a plurality of members:
retrieving a member profile associated with the respective member from the member profile data;
generating a member quality score for the respective member; and
based on the generated member quality score, determining whether the respective member is a quality member; and
selecting one or more members, from the plurality of members, for a social networking related communication, based at least in part on whether the members are determined to be quality members.

2. The method of claim 1, wherein retrieving the member profile associated with the respective member further includes:
accessing social graph data for the respective member.

3. The method of claim 1, wherein retrieving the member profile associated with the respective member further includes:
accessing member interaction data for the respective member.

4. The method of claim 1, wherein retrieving the member profile associated with the respective member further includes:
determining whether the member profile associated with the respective member includes member contact information.

5. The method of claim 1, wherein generating the member quality score for the respective member further includes:
determining a percentage of member profile data fields for which data has been supplied.

6. The method of claim 1, wherein generating the member quality score for the respective member further includes:
determining whether a client system associated with the respective member has a dedicated application associated with a social networking system installed.

7. The method of claim 1, wherein generating the member quality score for the respective member further includes:
determining a number of members that the respective member follows.

8. The method of claim 1, wherein generating the member quality score for the respective member further includes:
determining a percentage of a member profile that is filled out for the respective member.

9. The method of claim 1, wherein generating the member quality score for the respective member further includes:
determining a number of connections for the respective member.

10. The method of claim 1, wherein the generated member quality score is based, at least partially, on whether the member profile associated with the respective member includes contact information for the respective member.

11. The method of claim 1, wherein determining whether the respective member is a quality member further includes:
comparing the generated member quality score for the respective member with a predetermined threshold value.

12. The method of claim 11, wherein determining whether the respective member is a quality member further includes:
in accordance with a determination that the generated member quality score for the respective member exceeds the predetermined threshold value, assigning the respective member to a first member grouping.

13. The method of claim 11, wherein determining whether the respective member is a quality member further includes:
in accordance with a determination that the generated member quality score for the respective member does not exceed the predetermined threshold value, assigning the respective member to a second member grouping.

14. The method of claim 12, further comprising:
in accordance with the determination that the generated member quality score for the respective member does not exceed the predetermined threshold value, determining a member profile factor that at least partially resulted in the member quality score not exceeding the predetermined threshold value; and
transmitting a request to the respective member for information to improve the determined member profile factor.

15. A system comprising:
one or more processors;
memory; and
one or more programs stored in the memory, the one or more programs comprising instructions for:
for a respective member in a plurality of members:
retrieving a member profile associated with the respective member from the member profile data;
generating a member quality score for the respective member; and
based on the generated member quality score, determining whether the respective member is a quality member; and
selecting one or more members, from the plurality of members, for a social networking related communication, based at least in part on whether the members are determined to be quality members.

16. The system of claim 15, wherein the generated member quality score is based, at least partially, on whether the member profile associated with the respective member includes contact information for the respective member.

17. The system of claim 15, wherein determining whether the respective member is a quality member further includes:
comparing the generated member quality score for the respective member with a predetermined threshold value.

18. A non-transitory computer-readable storage medium storing instructions that, when executed by the one or more processors of a machine, cause the machine to perform operations comprising:
for a respective member in a plurality of members:
retrieving a member profile associated with the respective member from the member profile data;
generating a member quality score for the respective member; and
based on the generated member quality score, determining whether the respective member is a quality member; and
selecting one or more members, from the plurality of members, for a social networking related communication, based at least in part on whether the members are determined to be quality members.

19. The non-transitory computer-readable storage medium of claim 18, wherein the generated member quality score is based, at least partially, on whether the member profile associated with the respective member includes contact information for the respective member.

20. The non-transitory computer-readable storage medium of claim 18, wherein determining whether the respective member is a quality member further includes:
comparing the generated member quality score for the respective member with a predetermined threshold value.
